(19) United States
(12) Patent Application Publication
(10) Pub. No.: US 2004/0224835 A1
(43) Pub. Date: Nov. 11, 2004

(54) Ceramic carrier and production method thereof

(75) Inventors: Tomomi Hase, Kariya-city (JP); Kazuhiko Koike, Okazaki-city (JP); Shin-ichi Hirano, Chita-gun (JP)

Correspondence Address: NIXON & VANDERHYE, PC, 1100 N GLEBE ROAD, 8TH FLOOR, ARLINGTON, VA, 22201-4714, US

(73) Assignee: Denso Corporation, Aichi-Pref (JP)

(21) Appl. No.: 10/830,443

(22) Filed: Apr. 23, 2004

(30) Foreign Application Priority Data
Apr. 24, 2003 (JP) 2003-120142

(51) Int. Cl. C04B 35/195

(52) U.S. Cl. 501/119; 501/128

(57) ABSTRACT

A ceramic carrier comprising a substrate ceramic containing Mg, Al, Si and O as constituent elements and containing, as the second component, an element other than said constituent elements. The support contains many microvoids capable of absorbing thermal expansion, the porosity is larger than 28%, and the thermal expansion coefficient is smaller than 2.3×10⁻⁶/° C. The second component enables the direct loading of a catalytic component.

### FIELD OF THE INVENTION

The present invention relates to a ceramic carrier used to support a catalyst in, for example, an exhaust gas cleaning catalyst of an automobile engine, and a method for producing the ceramic carrier.

### BACKGROUND OF THE INVENTION

A ceramic carrier heretofore widely used to support a catalyst is cordierite (2MgO.2Al₂O₃.5SiO₂) having low thermal expansion and high thermal impact resistance. This ceramic carrier is generally used as a catalyst body by shaping cordierite into a honeycomb form and after coating the surface with γ-alumina, carrying a noble metal catalyst thereon. The coat layer is formed because the specific surface area of cordierite is small and a necessary amount of a catalyst component cannot be carried on the cordierite as it is. By using γ-alumina having a large specific surface area, the surface area of the carrier can be increased.

However, the coating of the carrier surface with γ-alumina causes a problem that the heat capacity increases due to an increase in the weight. In recent years, studies have been made to decrease the heat capacity by making the cell wall of the honeycomb carrier thin so as to attain early activation of the catalyst, but this effect is halved by the formation of the coat layer. Furthermore, the coat layer gives rise to the problems that the thermal expansion coefficient becomes large due to the coat layer and the pressure loss increases due to reduction in the cell opening area.

Accordingly, various studies are being made on a ceramic carrier where a catalytic component can be carried without forming a coat layer. For example, the specific surface area of cordierite itself can be increased by a method of subjecting the cordierite to an acid treatment and then to a heat treatment, but this method is disadvantageous and impracticable because the crystal lattice of cordierite is destroyed by the acid treatment or the like and the strength is decreased.

The present inventors have previously proposed a ceramic carrier where at least one of the elements constituting the substrate ceramic is replaced with an element other than the constituent elements and thereby a catalyst component can be made to be carried directly on the substrate ceramic as described in Japanese Unexamined Patent Publication (Kokai) No. 2001-310128. This directly carrying ceramic carrier can dispense with a coat layer for increasing the specific surface area, is free of a problem of reduction in the strength accompanying an acid treatment or the like and therefore, is promising as a catalyst for automobiles, which is required to have durability.

However, the thermal expansion coefficient of the directly carrying ceramic carrier increases due to introduction of the replacing element as compared with that of cordierite alone, though the increase is not as large as in the case of forming a coat layer. Therefore, it is required to enable direct carrying of a catalytic component while suppressing the increase of thermal expansion coefficient accompanying the introduction of a replacing element as much as possible and to maintain the excellent properties of cordierite.

The present invention has been made under these circumstances and an object of the present invention is to obtain a directly carrying ceramic carrier having higher performance and excellent practicability, where the properties of the substrate ceramic can be maintained and, at the same time, a catalytic component can be directly carried.

### SUMMARY OF THE INVENTION

According to a first aspect of the invention, the ceramic carrier comprises a substrate ceramic containing Mg, Al, Si and O as constituent elements and comprising, as the second component, an element other than these constituent elements to enable the direct carrying of a catalytic component. The ceramic carrier according to the invention is characterized by having a structure where many microvoids capable of absorbing thermal expansion are present between particles, the porosity is larger than 28% and the thermal expansion coefficient is smaller than 2.3×10⁻⁶/° C.

In the ceramic carrier according to the invention, a ceramic having Mg, Al, Si and O as constituent elements, such as cordierite, contains other element having a strong bonding force to a catalytic component, as the second component, where the second component makes a solid solution with cordierite and a catalytic component can be directly carried thereon. By having such a constitution, a coat layer can be dispensed with. Furthermore, as the porosity becomes larger than 28% due to presence of many microvoids between particles and the thermal expansion can be absorbed by the microvoids, a thermal expansion coefficient lower than 2.3×10⁻⁶/° C., which is difficult to attain in conventional directly carrying ceramic carriers, can be achieved. The directly carrying ceramic carrier having such low thermal expansion can be obtained by appropriately selecting the starting materials, accelerating the growth of ceramic crystal which will be the substrate and at the same time, preventing the increase of crystal particle size. Thus, a directly carrying ceramic carrier having an excellent thermal impact resistance and a high performance is realized.

In the ceramic carrier according to a second aspect of the invention, cordierite is used as the substrate ceramic. The substrate ceramic comprising Mg, Al, Si and O as constituent elements is preferably cordierite and using this material facilitates achieving the low thermal expansion.

In the ceramic carrier according to a third aspect of the invention, the amount of cordierite in the substrate ceramic is 25 mol % or more. In order to maintain the properties of the substrate ceramic, the amount of cordierite having solid-dissolved therein the second component is preferably 25 mol % or more. When the rate of cordierite crystal having a small thermal expansion coefficient is increased, this facilitates achieving the low thermal expansion.

In the ceramic carrier according to a fourth aspect of the invention, at least one element having a d or f orbital in its electron orbit is used as the second component. The second component element introduced into the substrate ceramic preferably has a large bonding force to a catalytic component. The energy level of the element having a d or f orbital is close to that of a catalytic component and therefore, donation of an electron readily occurs to facilitate the bonding.

In the ceramic carrier according to a fifth aspect of the invention, at least one element selected from Cr, Mo, W, Co, Ti, Fe, Ga, Ni, Cu, Zn, Sc, Y, Ge, Zr and Mn is used as the second component. These elements are the element having a d or f orbital. Introducing one or more of these elements as the second component into the substrate ceramic enables direct carrying of a catalytic component.

In the ceramic carrier according to a sixth aspect of the invention, W and Ti are contained as the second component and the starting material as the Ti source is a rutile titanium oxide. When W and Ti are used as the second component, the catalyst-carrying ability is enhanced. When a rutile titanium oxide is used as the starting material of Ti, the crystal particle size is prevented from increasing, and many microvoids on the sub-micron to micron order, which absorb the thermal expansion, are formed between particles and, as a result, the thermal expansion coefficient can be greatly decreased.

In the ceramic carrier according to a seventh aspect of the invention, out of the constituent elements of the substrate ceramic, the starting material as the Mg source is a clay mineral. When a clay mineral is used, the crystal is temporarily decomposed at the firing and the crystallization reaction is accelerated and, as a result, an amorphous phase having a high thermal expansion coefficient, which is formed between crystals, is reduced and an effect of decreasing the thermal expansion coefficient of the substrate ceramic can be obtained. Furthermore, when a clay mineral is used, an appropriate viscosity of facilitating the shaping can be imparted and this enables less processing of natural raw materials and a low cost.

In the ceramic carrier according to an eighth aspect of the invention, the clay mineral as the Mg source is talc. The clay mineral is preferably talc and when talc is used, since this is a plate-like crystal, the crystal after shaping is facilitated to have an orientating property. This orientation is useful and therefore, the thermal expansion coefficient can be decreased.

In the ceramic carrier according to a ninth aspect of the invention, out of the constituent elements of the substrate ceramic, the starting material as the Al source is an aluminum hydroxide. When an aluminum hydroxide is used, the crystal is temporarily decomposed at the firing due to evaporation of crystal water, the crystallization reaction is accelerated and, as a result, an amount of an amorphous phase having a high thermal expansion coefficient, which is formed between crystals, is reduced and an effect of decreasing the thermal expansion coefficient of the substrate ceramic is obtained.

In the ceramic carrier according to a tenth aspect of the invention, out of the constituent elements of the substrate ceramic, the starting material as the Si source is an amorphous silicon oxide. When an amorphous silicon oxide is used, the crystal particle size is prevented from increasing and voids on the sub-micron to micron order, which absorb the thermal expansion, are formed between particles, whereby an effect of decreasing the thermal expansion coefficient can be obtained. Furthermore, production of a crystal other than the desired crystal is prevented and the amount of the desired substance produced is increased.

In the ceramic carrier according to an eleventh aspect of the invention, the amorphous silicon oxide is fused silica or calcined kaolin. Specifically, fused silica or calcined kaolin can be used as the Si source and the effect of a tenth aspect can be easily obtained.

In the ceramic carrier according to a twelfth aspect of the invention, the porosity is 30% or more and the thermal expansion coefficient is 2.0×10⁻⁶/° C. or less. By having a large porosity, the voids which absorb the thermal expansion can be increased and the thermal expansion coefficient can be more decreased. Preferably, the above-described starting materials are appropriately combined, whereby a porosity of 30% or more and a low thermal expansion of 2.0×10⁻⁶/° C. or less can be achieved and a high-performance ceramic carrier can be realized.

According to the thirteenth aspect, the invention is a method for producing a ceramic carrier. The invention provide a method for producing a ceramic carrier comprising a substrate ceramic which is comprises the first component consisting of elements: Mg, Al, Si and O and the second component comprising of at least one of elements other than said elements to enable the direct carrying of a catalytic component,

wherein said method comprising;

providing W and Ti as said second component, a clay mineral as the Mg source, an aluminum hydroxide as the Al source, an amorphous silicon oxide as the Si source, tungsten or a tungsten compound as the W source and a rutile titanium oxide as the Ti source,

mixing these starting materials to obtain a ceramic raw material,

kneading the resulting ceramic raw material,

shaping the kneaded product,

firing the shaped product.

As described above, it has been found that in producing a directly carrying ceramic carrier comprising a ceramic having Mg, Al, Si and O as constituent elements, such as cordierite, where other element having a strong boding force to a catalytic component is introduced, the selection of starting materials greatly affects the properties of the obtained ceramic carrier. For example, when a clay mineral or an aluminum hydroxide is used, the crystal thereof is temporarily decomposed at the firing, the crystallization reaction is accelerated and, as a result, the amount of an amorphous phase formed between crystals is reduced and the thermal expansion coefficient is decreased. Furthermore, when an amorphous silicon oxide or a rutile titanium oxide is used, the crystal particle size is prevented from increasing and voids on the sub-micron to micron order, which absorb the thermal expansion, are formed between particles. Therefore, by appropriately combining these starting materials, the thermal expansion coefficient of the substrate ceramic can be greatly decreased.

In the method according to a fourteenth aspect of the invention, the clay mineral is talc. Preferably, talc is used as the clay mineral of the Mg source. Since talc has a plate-like crystal, the crystal after shaping is facilitated to have an orientating property. This orientation is useful and therefore, the thermal expansion coefficient can be decreased.

In the method according to a fifteenth aspect of the invention, the amorphous silicon oxide is fused silica or calcined kaolin. Preferably, as fused silica or calcined kaolin is used as the amorphous silicon oxide of the Si source, the crystal particle size is prevented from increasing and voids on the sub-micron to micron order, which absorb the thermal expansion, are formed between particles, whereby an effect of decreasing the thermal expansion coefficient can be obtained. Furthermore, production of a crystal other than the objective crystal is prevented and the amount of the objective substance produced is increased.

### BRIEF DESCRIPTION OF THE DRAWINGS

FIG. 1 is a histogram showing, by comparison, the change in thermal expansion coefficient when the starting materials are varied in Examples of the present invention;

FIG. 2(a) is a photograph (scanning electron microscope (SEM) observed image) showing the crystal structure of the ceramic carrier of Comparative Example 1;

FIG. 2(b) is a photograph (SEM observed image) showing the crystal structure of the ceramic carrier of Example 1;

FIG. 3 is a histogram showing by comparison the change in porosity when the starting materials are varied in Comparative Example 1 and Examples 2 and 3;

FIG. 4 is a histogram showing by comparison the amount of cordierite in the ceramic carriers of Examples 2 and 3; and

FIG. 5 is a histogram for describing the reaction process of the ceramic carrier of Example 3.

### DETAILED DESCRIPTION OF THE INVENTION

The present invention is described in detail below. The ceramic carrier of the present invention is a carrier capable of directly carrying where a substrate ceramic comprising Mg, Al, Si and O as constituent elements is used and an element other than these constituent elements is incorporated as the second component into the substrate ceramic, thereby enabling direct carrying of a catalytic component. More specifically, the second component is solid-dissolved in the substrate ceramic and a catalytic component can be bonded to the solid-dissolved second component and thereby directly carried. Also, the ceramic carrier of the present invention has a characteristic feature that many microvoids absorbing thermal expansion are present between particles, the porosity is larger than 28% and the thermal expansion coefficient is smaller than 2.3×10⁻⁶/° C. The porosity is preferably 30% or more, more preferably 35% or more. As the porosity is larger, the effect of absorbing the thermal expansion is higher and the thermal expansion coefficient more decreases. The thermal expansion coefficient is preferably 2.0×10⁻⁶/° C. or less, more preferably 1.5×10⁻⁶/° C. or less. Such a ceramic carrier can be realized by using specific starting materials for the Mg, Al and Si sources constituting the substrate ceramic and for the source of an element working out to the second component.

For the substrate ceramic, for example, cordierite having a theoretical composition represented by 2MgO.2Al₂O₃.5SiO₂ is preferably used. The cordierite has low thermal expansion and excellent thermal impact resistance and therefore, is suitable as a carrier for exhaust gas-cleaning catalysts which are required to have high temperature durability. In order to maintain the properties of cordierite, the amount of cordierite solid-dissolved in the entire ceramic carrier is preferably 25 mol % or more. The shape of the ceramic carrier is not particularly limited and the ceramic carrier may have various shapes such as honeycomb, foam, hollow yarn, fiber, powder and pellet.

For the second component, an element having a larger bonding force to a catalytic component carried than the metal elements (Mg, Al, Si) constituting the substrate ceramic and being capable of chemically bonding to the catalytic component is suitably used. Specific examples of such an element include elements having a d or f orbital in the electron orbit thereof. Among these, preferred are elements having an empty orbital in the d or f orbital. The element having an empty orbital in the d or f orbital is close in the energy level to the catalytic component carried such as catalytic noble metal and therefore, donation of an electron readily occurs. Also, an element having two or more oxidation states readily undergoes the donation of an electron and is easily bonded to the catalytic component.

Specific examples of the element having an empty orbital in the d or f orbital include Sc, Ti, V, Cr, Mn, Fe, Co, Ni, Cu, Zn, Y, Ge, Zr, Nb, Mo, Tc, Ru, Rh, La, Ce, Pr, Nd, Pm, Sm, Eu, Gd, Tb, Dy, Ho, Er, Tm, Lu, Hf, Ta, W, Re Os, Ir and Pt. Among these elements, Ti, V, Cr, Mn, Fe, Co, Ni, Nb, Mo, Tc, Ru, Rh, Ce, Pr, Eu, Tb, Ta, W, Re, Os, Ir and Pt are elements having two or more oxidation states. Preferably, at least one or more element selected from Cr, Mo, W, Co, Ti, Fe, Ga, Ni, Cu, Zn, Sc, Y, Ge, Zr and Mn can be used. More preferably, W and Ti can be used in combination.

In order to incorporate such an element having an empty orbital in the d or f orbital into the substrate ceramic, usually, a constituent element of the substrate ceramic is replaced by a second component element and the second component element is solid-dissolved, whereby an element having a strong bonding force to a catalytic component can be caused to exist on the ceramic carrier surface. A second component element can directly carry these elements or a catalytic component. In replacing a constituent element (Mg, Al, Si) of the substrate ceramic by the second component, the solid-dissolved amount of the second component element is 5 ppb or more, preferably 5 ppm or more, based on the number of atomic of the constituent element replaced. When the solid-dissolved amount is 5 ppb or more, for example, a catalytic component having an average particle size of 50 nm can be carried in an amount of 0.01 g/L or more and the catalytic performance required in the normal ceramic catalyst carrier for vehicles can be satisfied. When the average particle size of the catalytic component is 5 nm, the solid-dissolved amount is preferably 5 ppm or more.

The solid-dissolved amount of the second component element is more preferably from 0.01 to 50% of the number of atomic of the constituent element replaced. If the total amount of second component elements is less than 0.01%, the number of sites where the catalytic component can be carried decreases, whereas if it exceeds 50%, the properties of the substrate ceramic are disadvantageously lost. In the case where one constituent element is replaced by a plurality of second component elements, the total replacing amount should be adjusted within the above-described range. Usually, the amount solid-dissolved is optimized according to the kind of the substrate ceramic or second component element. That is, the solid-dissolved amount is appropriately selected so that a necessary carried amount of catalyst can be ensured without decreasing the mechanical properties of the substrate ceramic, such as strength and thermal expansion coefficient, the heat resistance, the weather resistance and the like. For example, when the substrate ceramic is cordierite and the second component elements are W and Ti, the solid-dissolved amount of the second component elements is optimally from 2 to 7% of the number of atomic of the constituent element replaced.

In producing the ceramic carrier of the present invention, for example, at the time of preparing the raw material of the substrate ceramic, a part of the raw material for the constituent element (Mg, Al, Si) to be replaced is previously decreased according to the replacing amount and the raw material for the second component element is added in a predetermined amount. This ceramic raw material is mixed and, after kneading, shaping and drying it by an ordinary method, is fired in an atmospheric environment. At this time, in the present invention, specific compounds are used for the starting materials as the Mg, Al and Si sources and for the starting material of the second component element, because the reactivity and the like in the crystallization reaction at the firing vary depending on the starting materials. By appropriately combining these starting materials, the microstructure and porosity of the obtained ceramic carrier can be controlled and the thermal expansion coefficient can be decreased.

Specifically, for the constituent elements (Mg, Al, Si) of the ceramic carrier of the present invention, a clay mineral is used as the Mg source. When a clay mineral is used as the starting material, the crystal is temporarily decomposed at the firing and the crystallization reaction is accelerated, as a result, an amorphous phase having a high thermal expansion coefficient, which is formed between crystals, is reduced and the thermal expansion coefficient of the ceramic carrier is decreased. Furthermore, when a clay mineral is used, an appropriate viscosity of facilitating the shaping can be imparted and this enables less processing of natural raw materials and low cost. The clay mineral is preferably talc and, when talc is used, as this is a plate-like crystal, the crystal after shaping is facilitated to have an orientating property. This orientation is useful and therefore, the thermal expansion coefficient can be decreased.

Out of the constituent elements of the substrate ceramic, the Al source is preferably an aluminum hydroxide. When an aluminum hydroxide is used the starting material, the crystal is temporarily decomposed at the firing due to evaporation of crystal water and the crystallization reaction is accelerated, as a result, an amorphous phase having a high thermal expansion coefficient, which is formed between crystals, is reduced and an effect of decreasing the thermal expansion coefficient of the substrate ceramic is obtained. As the Al source, an inexpensive alumina may also be used in combination.

Out of the constituent elements of the substrate ceramic, the Si source is generally kaolin, and is preferably an amorphous silicon oxide. When an amorphous silicon oxide is used as the starting material, the crystal particle size is prevented from increasing and microvoids on the sub-micron to micron order, which absorb the thermal expansion, are formed between particles, whereby an effect of decreasing the thermal expansion coefficient can be obtained. Furthermore, production of a crystal other than the objective crystal (for example, cordierite) is prevented and the amount of the objective substance produced can be increased. The amorphous silicon oxide can be preferably fused silica or calcined kaolin. The calcined kaolin can be obtained by calcining, for example, kaolinite, dekkite or halloysite.

As the second component, various elements described above can be used but, particularly, when Ti is used and a rutile titanium oxide (rutile TiO₂) is used as the Ti source, the thermal expansion coefficient can be effectively decreased. By using a rutile titanium oxide, an effect of preventing the crystal particle size from increasing and forming microvoids on the sub-micron to micron order, which absorb the thermal expansion, between particles is obtained and the thermal expansion coefficient can be greatly decreased. Furthermore, when W is used, the bonding force to a catalytic component is strengthened. Therefore, W and Ti are preferably used in combination and this can realize enhancement of the catalyst-carrying ability and reduction of the thermal expansion and is more effective. The starting material of W is preferably tungsten or a tungsten compound such as tungsten oxide (WO₃).

Suitable examples of the catalytic component carried on the ceramic carrier of the present invention include noble metal elements such as Pt, Rh, Pd, Ru, Au, Ag, Ir and In. At least one or more member selected from these noble metal elements can be used. At this time, the average particle size of the catalytic noble metal is preferably 100 nm or less. By using a particle size of 100 nm or less, the cleaning performance per weight of catalyst can be enhanced. If desired, various co-catalysts can be added. Examples of the co-catalyst include metal elements such as Hf, Ti, Cu, Ni, Fe, Co, W, Mn, Cr, V, Se, Rb, Sr, Y, Zr, Nb, Mo, Tc, Ru, Sc, Ba, Ka and lanthanoid element (e.g., La, Ce, Pt, Nd, Pm, Sm, Eu, Gd, Tb, Dy, Ho, Er, Tm, Yb, Lu), and oxides or composite oxides thereof. Depending on the purpose such as prevention of deterioration, oxygen-occluding ability and detection of catalyst deterioration, one catalytic component or multiple catalytic components selected from these elements can be used.

Such a catalytic component is usually loaded on the ceramic carrier of the present invention by a method of immersing the ceramic carrier into a solution containing a desired catalytic component, and drying and then firing it. In the case of using two or more catalytic components in combination, a solution containing a plurality of catalytic components is prepared and the ceramic carrier is immersed into the solution. For example, in the case of using Pt and Rh as the main catalytic components, a solution containing hexachloroplatinic acid and rhodium chloride may be used. Also, various co-catalytic components may be used in combination. The amount of the catalytic component carried is preferably from 0.05 to 10 g/L for the catalytic noble metal and from 1 to 250 g/L for the co-catalyst.

The invention will be more clearly understood with reference to the following examples:

### EXAMPLES

### Examples 1 to 3, and Comparative Example 1

According to the method described above, a ceramic carrier of the present invention was produced, where cordierite was used as the substrate ceramic and W and Ti were used as the second component and solid-dissolved. For the starting materials of W and Ti, tungsten oxide (WO₃) and rutile titanium oxide (rutile TiO₂) were used. For the starting materials of the metal elements (Al, Mg, Si) constituting the cordierite, talc as the clay mineral working out to the Mg source, aluminum hydroxide (Al(OH)₃) and alumina (AlO₂) as the Al source, and kaolin as the Si source were used. After replacing 5% of the Si source by W and replacing 5% of the same Si source by Ti, the powders of these starting materials were mixed to approximate to the theoretical composition point of cordierite. Thereafter, a binder, a lubricant, a humectant and the like, each in an appropriate amount, were added to the resulting mixed raw material and kneaded by an ordinary method and the kneaded raw material was shaped and dried. The dried body was degreased at 900° C. in an atmospheric environment and then fired at 1,260° C. to obtain a ceramic carrier sample of the present invention (Example 1).

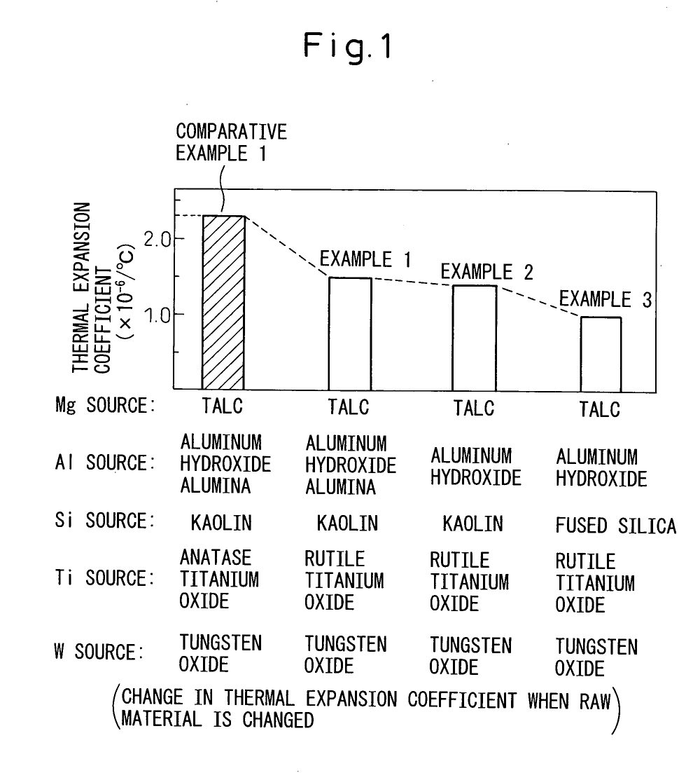

Also, a ceramic carrier was obtained in the same manner by using the same starting materials except that only aluminum hydroxide was used as the Al source (Example 2). Furthermore, ceramic carriers were obtained in the same manner except that fused silica which is an amorphous silicon oxide was used as the Si source (Example 3) and that anatase titanium oxide was used as the Ti source (Comparative Example 1). The thermal expansion coefficient of each of the obtained ceramic carriers was measured and the results are shown in FIG. 1.

As apparent from FIG. 1, in all of Examples 1 to 3 using rutile titanium oxide, the thermal expansion coefficient was 1.5×10⁻⁶/° C. or less and thus, a low thermal expansion of 2.0×10⁻⁶/° C. or less, which is conventionally difficult to attain, could be achieved. In Example 2 using only aluminum hydroxide as the Al source, the thermal expansion coefficient was lower (i.e. 1.4×10⁻⁶/° C.) than the thermal expansion coefficient (i.e. 1.5×10⁻⁶/° C.) of Example 1 using alumina in combination with aluminum hydroxide, and in Example 3 using fused silica as the Si source, the thermal expansion coefficient was more decreased (i.e. 1.0×10⁻⁶/° C.). On the contrary, in Comparative Example 1 using anatase titanium oxide, the thermal expansion coefficient was as large as 2.3×10⁻⁶/° C. and this reveals that the selection of starting materials greatly affects the properties of the obtained ceramic carrier.

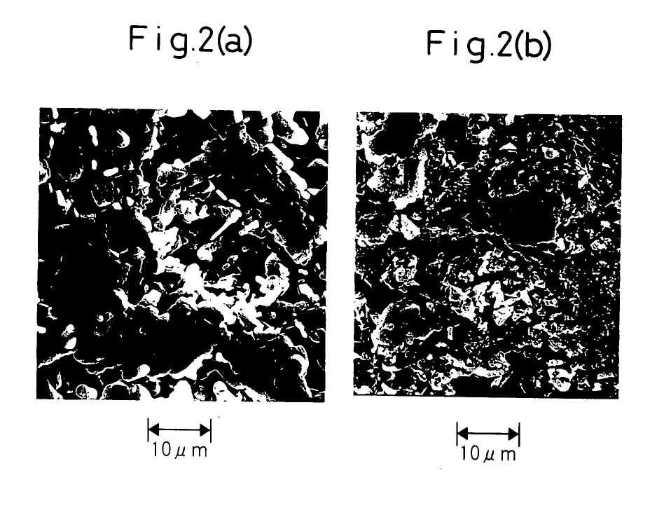

FIGS. 2(a) and 2(b) show SEM observed photographs of ceramic carriers of Comparative Example 1 and Example 2, respectively. As apparent from comparison of these photographs, the sample of Example 2 using aluminum hydroxide and rutile titanium oxide is smaller in the crystal particle size than the sample of Comparative Example 1 using alumina, aluminum hydroxide and anatase titanium oxide. It is also seen that in Comparative Example 1, voids are less formed between a particle and a particle, but in Example 2, many voids on the sub-micron to micron order are formed between particles. This is believed to result because when anatase titanium oxide is used, the reaction proceeds to cause a melted state and the particles are melt-bonded to each other, as a result, voids are less formed between a particle and a particle, whereas, when rutile titanium oxide is used, the reaction is suppressed and voids are readily formed between particles.

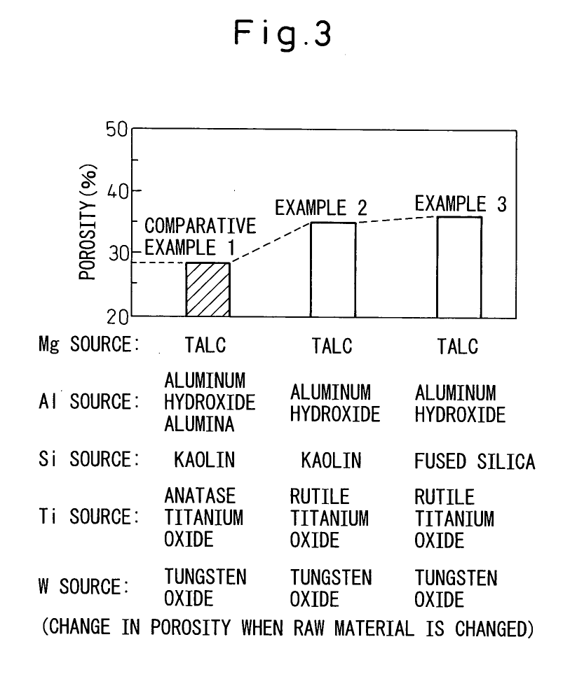

FIG. 3 shows the results in the measurement of porosity of ceramic carriers of Comparative Example 1 and Examples 2 and 3. In FIG. 3, the porosity of Comparative Example 1 using alumina, aluminum hydroxide and anatase titanium oxide is 28%, whereas in Examples 2 and 3 using aluminum hydroxide and rutile titanium oxide, the porosity exceeds 35%. As apparent from this result, by appropriately selecting the starting materials, the crystal particle size can be prevented from increasing and many voids on the sub-micron to micron order can be formed between particles to give a porosity of 30% or more. The reason why the thermal expansion coefficient is decreased in samples of Examples 2 and 3 is because when particles are expanded due to heat, the microvoid is first closed and the expansion of the carrier is not generated (that is a state that the thermal expansion is absorbed). If the particles are expanded to exceed the voids between particles, thermal expansion of the carrier would occur.

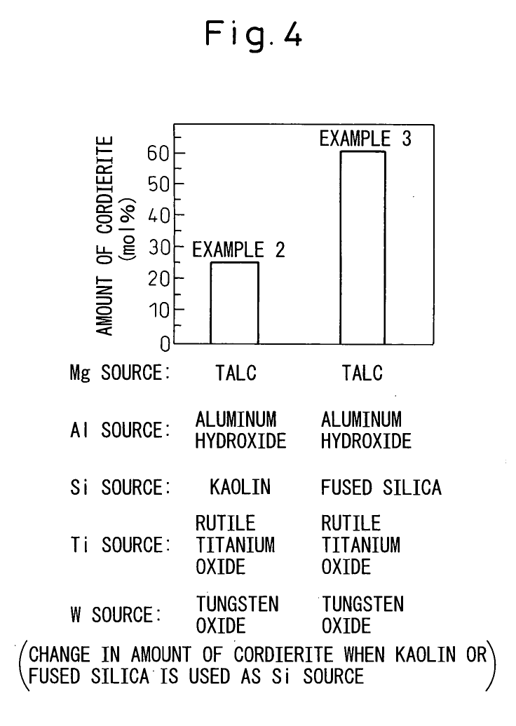

The porosity of Example 3 using fused silica as the Si source is larger than the porosity of Example 2 using kaolin as the Si source and this reveals that when fused silica is used, the effect of preventing the increase of crystal particle size and forming microvoids between particles is increased. Furthermore, as shown in FIG. 4, in Example 3 using fused silica, the amount of cordierite occupying in the entire substrate is exceeding 60 mol % and this reveals that when fused silica is used, the crystallization reaction of cordierite is accelerated and the amount of cordierite produced increases. By virtue of the absorption of thermal expansion by microvoids and the increase of the cordierite having low thermal expansion, as shown in FIG. 1, the thermal expansion is greatly decreased.

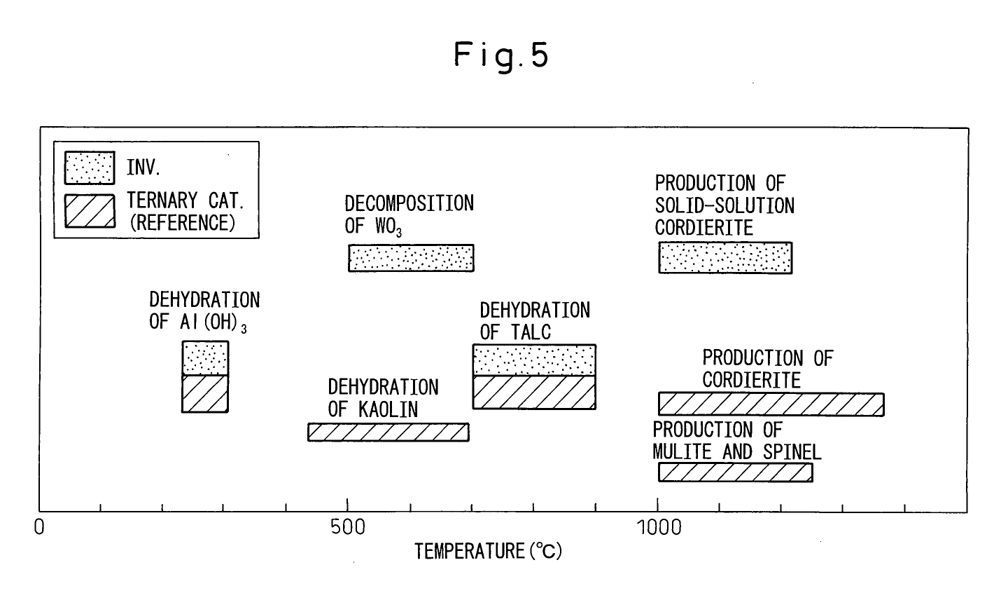

FIG. 5 shows a reaction process when a ceramic carrier is produced by using talc as the Mg source, aluminum hydroxide as the Al source and fused silica as the Si source, adding tungsten oxide and rutile titanium oxide thereto and mixing these. In this case, the aluminum hydroxide is dehydrated at 200 to 300° C. and becomes amorphous, then the tungsten oxide is dehydrated at 500 to 700° C. and becomes amorphous, and the talc is dehydrated at 700 to 900° C. and becomes amorphous. These aluminum hydroxide, tungsten oxide and talc each turned into the amorphous state and the fused silica remaining as it is all the way are reacted from 1,000° C. to produce a solid-solution cordierite.

Conventionally, in producing a ceramic carrier, materials having good reactivity has tended to be selected as the starting materials. However as can be seen from the results in FIGS. 1 to 5, the starting materials have a great effect, and such tendency is not necessarily proper. For example, it is believed that the thermal expansion can be decreased and not only the production of a crystal other than cordierite but also the increase of crystal particle size can be suppressed by using fused silica in place of kaolin which undergoes dehydrating decomposition at a relatively low temperature. Also in the case of titanium oxide, by using a rutile type to give appropriate reactivity in place of anatase type having good reactivity, the crystal particle size can be prevented from increasing and voids can be formed between particles. When the ceramic carrier is expanded due to heat, the void is first closed and the expansion as the carrier is not generated (that is a state that the thermal expansion is absorbed), as a result, the thermal expansion coefficient can be decreased.

As described in the foregoing pages, according to the ceramic carrier of the present invention, the starting materials are appropriately selected and combined, whereby the amount of cordierite produced, the crystal particle size, the porosity and the like can be controlled, the thermal expansion coefficient can be decreased and the thermal impact resistance can be greatly enhanced.

1. A ceramic carrier comprising a substrate ceramic which is comprises the first component consisting of elements: Mg, Al, Si and O and the second component comprising of at least one of elements other than said elements to enable the direct carrying of a catalytic component,
wherein said support is comprised of particles and microvoids formed between the plural particles, which microvoids absorb thermal expansion, and has porosity of larger than 28% and thermal expansion coefficient of smaller than 2.3×10⁻⁶/° C.

2. The ceramic carrier as claimed in claim 1, wherein said substrate ceramic is cordierite.

3. The ceramic carrier as claimed in claim 2, wherein the amount of cordierite is 25 mol % or more.

4. The ceramic carrier as claimed in claim 1, wherein said second component is at least one element having a d or f orbital in its electron orbit.

5. The ceramic carrier as claimed in claim 1, wherein said second component is at least one element selected from Cr, Mo, W, Co, Ti, Fe, Ga, Ni, Cu, Zn, Sc, Y, Ge, Zr and Mn.

6. The ceramic carrier as claimed in claim 1, wherein N and Ti are contained as said second component and a rutile titanium oxide is used as a Ti source in the production of said ceramic carrier.

7. The ceramic carrier as claimed in claim 1, wherein a clay mineral is used as a Mg source in the production of said ceramic carrier.

8. The ceramic carrier as claimed in claim 7, wherein said clay mineral is talc.

9. The ceramic carrier as claimed in claim 1, wherein an aluminum hydroxide is used as an Al source in the production of said ceramic carrier.

10. The ceramic carrier as claimed in claim 1, wherein an amorphous silicon oxide is used as a Si source in the production of said ceramic carrier.

11. The ceramic carrier as claimed in claim 10, wherein said amorphous silicon oxide is fused silica or calcined kaolin.

12. The ceramic carrier as claimed in claim 1, wherein the porosity is 30% or more and the thermal expansion coefficient is 2.0×10⁻⁶/° C. or less.

13. A method for producing a ceramic carrier comprising a substrate ceramic which is comprises the first component consisting of elements: Mg, Al, Si and 0 and the second component comprising of at least one of elements other than said elements to enable the direct carrying of a catalytic component,
wherein said method comprising;
providing W and Ti as said second
component, a clay mineral as the Mg source, an aluminum hydroxide as the Al source, an amorphous silicon oxide as the Si source, tungsten or a tungsten compound as the W source and a rutile titanium oxide as the Ti source,
mixing these starting materials to obtain a ceramic raw material,
kneading the resulting ceramic raw material shaping the kneaded product, firing the shaped product.

14. The method for producing a ceramic carrier as claimed in claim 13, wherein said clay mineral is talc.

15. The method for producing a ceramic carrier as claimed in claim 13, wherein said amorphous silicon oxide is fused silica or calcined kaolin.
